(19) United States
(12) Patent Application Publication
(10) Pub. No.: US 2020/0012673 A1
(43) Pub. Date: Jan. 9, 2020

(54) SYSTEM, METHOD AND COMPUTER PROGRAM PRODUCT FOR QUERY CLARIFICATION

(71) Applicants: UNIVERSITY OF WATERLOO, Waterloo (CA); THE GOVERNING COUNCIL OF THE UNIVERSITY OF TORONTO, Toronto (CA); THE UNIVERSITY OF WESTERN ONTARIO, London (CA); UNIVERSITY HEALTH NETWORK, Toronto (CA)

(72) Inventors: Frank RUDZICZ, Toronto (CA); Jennifer Netanis BOGER, Waterloo (CA); Hamidreza CHINAEI, Montreal (CA); Janice Ann POLGAR, London (CA); Muuo WAMBUA, Toronto (CA)

(21) Appl. No.: 16/459,851

(22) Filed: Jul. 2, 2019

Related U.S. Application Data
(60) Provisional application No. 62/693,888, filed on Jul. 3, 2018.

(51) Int. Cl. G06F 16/332; G06F 16/242; G06K 9/62; G06N 5/00

(52) U.S. Cl. CPC G06F 16/3325; G06F 16/242; G06N 5/003; G06K 9/6264; G06K 9/6256

(57) ABSTRACT

A system, method and computer program product for query clarification are described. Data from a corpus is automatically labelled using a trained classifier. The labels are assigned to indicator variables that each relate to the context of each data. During query, a decision tree is generated from the search results in such a way as to maximize information gain obtainable from a question:answer pair that can be posed to the user. The search results can be narrowed by obtaining the answer and correspondingly pruning the decision tree.

### TECHNICAL FIELD

The following relates generally to interactive computerized search, and more specifically, to a computer-based system, method and computer program product for query clarification.

### BACKGROUND

Modern search engines place an enormous amount of information within reach, but can offer disappointing results when users are unable to form their queries with sufficient specificity. Query disambiguation permits search engines to determine context of a particular search in an effort to deliver relevant results.

One common method for query disambiguation is to use personalization, which builds a user profile which is then used to tailor results to the user's interests. Personalization can make use of a user's short- (within session) and long-term (historic) browsing behaviour to disambiguate a user's query within a given session. For example, webpages previously or repeatedly visited by a user are often highly relevant to these or other similar users. Other systems have considered information external to searches, such as email messages, calendar items, or documents on the user's device. Generally speaking, the richer the representation of the user, the better.

Query expansion is another common method for search refinement. Query expansion seeks to rewrite the query so as to retrieve a smaller set of results. For example, queries can be supplemented with words similar to the original query.

There are cases where query disambiguation and/or query expansion are insufficient to locate the most relevant search result for a user. It is therefore an object of the present invention to provide a system, method and computer program product in which the above disadvantages are obviated or mitigated and attainment of the desirable attributes is facilitated.

### SUMMARY

In one aspect, a system for query clarification applied to a set of search results generated by a search query performed on a corpus of data is provided, the system comprising one or more processors configured to execute: a labelling engine to apply to each datum within the corpus a label corresponding to each one of a plurality of predetermined indicator variables, each indicator variable relating to context of the respective data; and a clarification engine to: generate a decision tree using the set of search results, the decision tree comprising nodes corresponding to the indicator variables and edges corresponding to the labels, the decision tree generated to maximize information gain based on pruning the decision tree in response to obtaining a desired label for a selected indicator variable; and prune the decision tree in response to a question posed to a user to obtain a label for an indicator variable.

In a particular case, each indicator variable corresponds to a question and each label of associated edges corresponds to an answer associated with the question.

In another case, each indicator variable represents a category of interest to a particular field represented by the corpus of data.

In yet another case, at least one of the labels is unknown.

In yet another case, each datum in the corpus comprises one or more webpages.

In yet another case, at least a portion of the data are manually labelled and the labelling engine applies inheritance of the labels to webpages associated with the manually labelled data.

In yet another case, the labelling engine uses a trained supervised learning classifier for each of the indicator variables to label the data, the supervised learning classifier trained using a set of manually labelled data for training and testing.

In yet another case, maximizing information gain comprises determining the information gained in knowing a value of each indicator variable, the indicator variable with a largest potential information gain being used to split the search results into subsets according its value to produce a node in the decision tree, and wherein the question posed to the user results in obtaining a label or value for the indicator variable.

In yet another case, the clarification engine iteratively performs, to prune the decision tree, determining the information gained and posing the question to the user that will provide the largest information gain.

In yet another case, information gain is determined by determining a probability that the answer provided by the user to each question is accurate, and that a desired search result to the search query will be found in the set of documents represented within that answer.

In another aspect, a computer-implemented method for query clarification applied to a set of search results generated by a search query performed on a corpus of data is provided, the method comprising: applying to each datum within the corpus a label corresponding to each one of a plurality of predetermined indicator variables, each indicator variable relating to context of the respective data; generating a decision tree using the set of search results, the decision tree comprising nodes corresponding to the indicator variables and edges corresponding to the labels, the decision tree generated to maximize information gain based on pruning the decision tree in response to obtaining a desired label for a selected indicator variable; and pruning the decision tree in response to a question posed to a user to obtain a label for an indicator variable.

In a particular case, each indicator variable corresponds to a question and each label of associated edges corresponds to an answer associated with the question.

In another case, each indicator variable represents a category of interest to a particular field represented by the corpus of data.

In yet another case, at least one of the labels is unknown.

In yet another case, each datum in the corpus of data comprises one or more webpages.

In yet another case, at least a portion of the data are manually labelled and the labelling engine applies inheritance of the labels to webpages associated with the manually labelled data.

In yet another case, applying the label comprises using a trained supervised learning classifier for each of the indicator variables to label the data, the supervised learning classifier trained using a set of manually labelled data for training and testing.

In yet another case, maximizing information gain comprises determining the information gained in knowing a value of each indicator variable, the indicator variable with a largest potential information gain is used to split the search results into subsets according its value to produce a node in the decision tree, and wherein the question posed to the user comprises posing a question to the user results in obtaining a label or value for the indicator variable.

In yet another case, pruning the decision tree comprises iteratively determining the information gained and posing the question to the user that will provide the largest information gain.

In yet another case, information gain is determined by determining a probability that the answer provided by the user to each question is accurate, and that a desired search result to the search query will be found in the set of documents represented within that answer. In one aspect, a system for query clarification applied to a set of search results generated by a search query performed on a corpus of data is provided, the system comprising: a labelling engine configured to apply to each datum within the corpus a label corresponding to each one of a plurality of predetermined indicator variables, each indicator variable relating to context of the respective data; and a clarification engine configured to: generate a decision tree using the set of search results, the decision tree comprising nodes corresponding to the indicator variables and edges corresponding to the labels, the decision tree generated to maximize information gain based on pruning the decision tree in response to obtaining a desired label for a selected indicator variable; and prune the decision tree in response to a question posed to a user to obtain a label for an indicator variable.

In further aspects, methods and computer programs for implementing the system are provided.

### DESCRIPTION OF THE DRAWING

The features of the invention will become more apparent in the following detailed description in which reference is made to the appended drawings wherein:

FIG. 1 illustrates a system for query clarification;

FIG. 2 illustrates a method for labelling a corpus of data with indicator variable labels;

FIG. 3 illustrates an exemplary artificial neural network for use with the presently disclosed system;

FIG. 4A and B illustrate methods for query clarification using data labelled in accordance with FIG. 2; and

FIG. 5A to 5D illustrate web based user interfaces for operating the presently disclosed system.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to interactive computerized search, and more specifically, to a computer-based system, method and computer program product for query clarification. The method and system described herein utilize categorization of data within the corpus of information to be searched in order to assist the user in obtaining a desired search result. The system comprises a trained model for labelling data within a corpus with indicator variable values, whereby the values are indicative of categories of interest to users conducting searches on the corpus, and a clarification engine for interacting with users to refine search results on the basis of the categories.

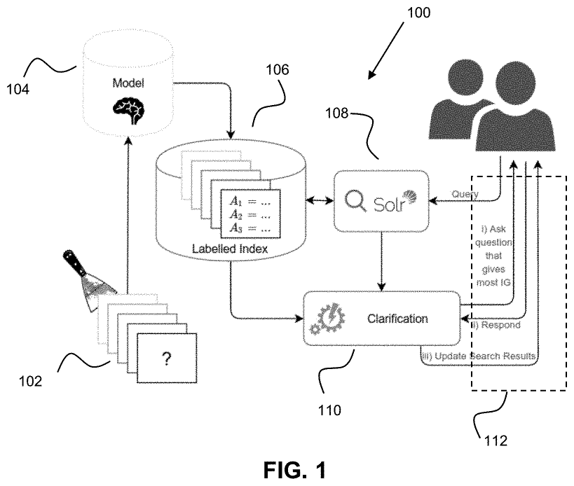

Referring first to FIG. 1, a system (100) for query clarification is shown. The system comprises a corpus of data (102), a labelling engine (104) for labelling the data in the corpus (102), a labelled index database (106) for indexing the data on the basis of the labels, a search engine (108) for searching among the data, and a clarification engine (110) for query clarification. The system (100) may further comprise a user interface (112) for interacting with users. The user interface (112) could instead implement an API for integrating with a third party user interface. The corpus of data (102) and the labelled index database (106) can be located, for example, on one or more data storage devices such as a local or remote database. The labelling engine (104), the search engine (108) and the clarification engine (110) can be executed on one or more local or remote processors.

In brief, the corpus of data (102) is any grouping of references of interest to a user. This could include, for example, the contents of the world wide web or any particular subset thereof; it could alternatively include proprietary data repositories. An illustrative example described below comprises web pages selected from various sources that are related to dementia diagnosis, treatment and care. The corpus could be generated using a web crawler on a set of websites. For example, the corpus could be generated using Apache™ Nutch™. In a more particular example, the web crawler can be used to generate a seed set of data, preferably obtained from reliable data, and from this seed set additional data may be added to the corpus in a breadth-first search to a predetermined depth.

For this type of example, the presently disclosed system and method ingest the data in the corpus and apply labels to each data item in the corpus. The labels are associated with a plurality of indicator variables which are related to the context of the data. Exemplary context is the type of source of the data—whether generated by users or institutions—and the accessibility of the data—whether free or paid. Several other indicator variables are described below for this example. Each of these indicator variables effectively act as potential “questions”, e.g., is the content free or does it require a payment? The labels comprise the various potential “answers” to the indicator variable “questions”. When a search is conducted, the search engine returns relevant results and the clarification engine generates a decision tree using these results. The decision tree is generated using nodes that are the indicator variables and edges that correspond to each label, and the decision tree is generated in order to determine the indicator variable that, if posed as a question to which the user responds, provides the most information gain for narrowing the search results. The decision tree can then be regenerated and a new question posed, iteratively, until a desired number of search results remains. A more detailed explanation now follows.

The query clarification method provided herein permits personalization of search results to the user without requiring a user profile. Rather, the query clarification method utilizes a direct question and answer process with the user to permit the user to navigate amongst possible search result categories.

Although question and answer search refinement has been used, for example, in virtual assistants and chatbots, the method and system described herein utilizes categorization of data (possible search results) in a corpus that is based on the context, rather than merely the content, of that data. In other words, the clarifying questions are not necessarily selected by determining the content of various data items and querying the user to select a most relevant content. Rather, the presently described system utilizes a predefined (depending on the field represented by the corpus) set of relevant semantic categories with which search results are subdivided, wherein each semantic category is represented as an indicator variable. The filtering (narrowing, selecting, ranking) of search results is conducted based on user responses to clarifying questions that are related to the indicator variables.

In embodiments, the system may begin with an existing ontology (such as the Yahoo™ subject hierarchy, or similar, for webpages) to train a classifier to automatically classify the data (such as webpages, for example) into ontological concepts which is then used to re-rank or filter results based on the user's profile of concepts. Categories can also be dynamically generated: automatically cluster search results into subsets, automatically generating a proposed query for each.

As previously mentioned, the present technique categorizes search result candidates based on a plurality of indicator variables. The set of indicator variables may be selected to reflect categories of interest and relevance to users in a particular field represented by the corpus of information being searched. The indicator variables can be considered as metadata that correspond to a Question:Answer pair, where the questions relate to the indicator variable and the possible answers relate to the labels that could populate each indicator variable. Illustrative examples of such Question:Answer pairs are Audience:Researchers (as opposed to Audience:Patients or Audience:Caregivers, for example) or Payment:Subscription (as opposed to Payment:Free, for example). Further examples are shown below in Table 1, which show an example of indicator variables and associated labels that might be relevant for querying a corpus of medical diagnostic or treatment data.

TABLE 1

| | Indicator variable | Labels/Values |
|---|---|---|
| ind-1 | Audience | Patients, Caregivers, Health Care |
| | | Professionals, Researchers |
| ind-2 | Payment | Free, Subscription, Optional |
| | | Subscription |
| ind-3 | Location | Physical site, Web Only |
| ind-4 | Forum | Yes, No |
| ind-5 | Information Generation | Users, Institution |
| ind-6 | Definitions of Disease | Yes, No, Sometimes |
| ind-7 | Progression/Stages | Yes, No |
| ind-8 | Medication/Treatment | Yes, No, Sometimes |
| ind-9 | Diet/Nutrition | Yes, No, Sometimes |
| ind-10 | Patient Neuropsyche | Yes, No |
| ind-11 | Caregiver Neuropsyche | Yes, No |
| ind-12 | Risk Factors, Warning | Yes, No |
| ind-13 | Adult Day Care | Yes, No |
| ind-14 | Community Help (unpaid) | Internal, External, Yes, No |
| ind-15 | Community Help (paid) | Internal, External, Yes, No |
| ind-16 | Driving/Other Activities | Yes, No |
| ind-17 | Financial (Aid, Advice) | Yes, No |
| ind-18 | Legal (Aid, Advice) | Yes, No |

The example indicator variables shown in Table 1 are merely illustrative and not to be considered limiting to the claims. In practice, the set of ‘indicator variables’ and potential labels could be developed through focus groups of users interested in the corpus to determine the most important kinds of information. The indicator variables shown in Table 1, for example, were developed through focus groups of caregivers of individuals with dementia.

In addition, the system may be configured to apply labels to a subset of indicator variables for any particular data item. In other words, it may not be necessary to apply a label to all indicator variables; some may be left unknown. The reason for leaving indicator variables unknown could be computed, e.g., according to the confidence of the classifier given the datum.

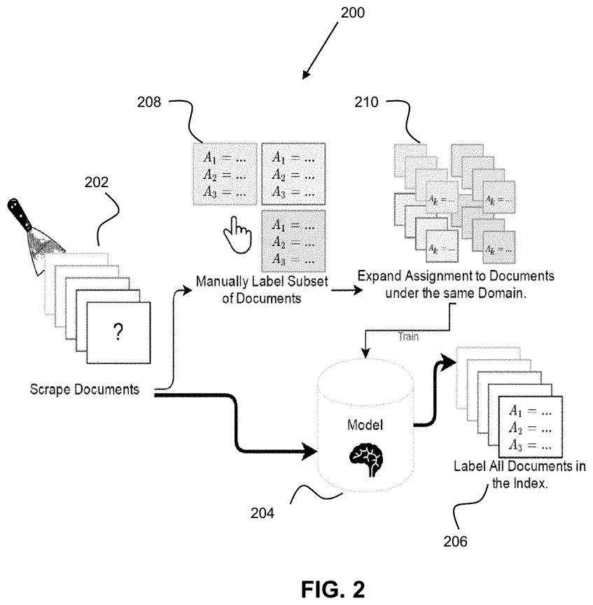

Referring now to FIG. 2, the corpus data (202), which may as previously mentioned be web pages, are automatically tagged using a classifier trained on a labelled corpus of representative data. The labelling engine (104) is configured with the set of indicator variables and applies a trained labelling model (204) for labelling (208) the data in the corpus. It may be preferable depending on the model utilized for a subset of data in the corpus, or from a representative corpus, to be manually annotated (208), for purposes of training the model for further labelling. For the purposes of limiting human involvement, labels may be applied across subsets of data. For example, depending on the nature of the corpus, the indicator variables, and the possible labels, it may be possible to manually label (208) websites each containing a plurality of web pages, and configuring the labelling engine (104) to apply inheritance of the labels to these web pages (210). In a particular example using the indicator variables shown in Table 1, labelling a web site requiring a subscription with the Payment:Subscription label is highly likely to result in accurate labelling of the Payment variable of the web pages in that web site.

Given a subset of the data labelled with their respective indicator variable labels, the labelling engine (104) applies supervised learning to obtain a model that automatically labels new documents with inferred indicator variable labels. Depending on the quantity of data available, some number of data items in a first subset of the labelled documents may be used for training, and the remainder in a second subset for testing. A separate classifier is used for each indicator variable. In a particular example, with the number of labelled data being 1688, two-thirds of the data were used for training and one-third for testing.

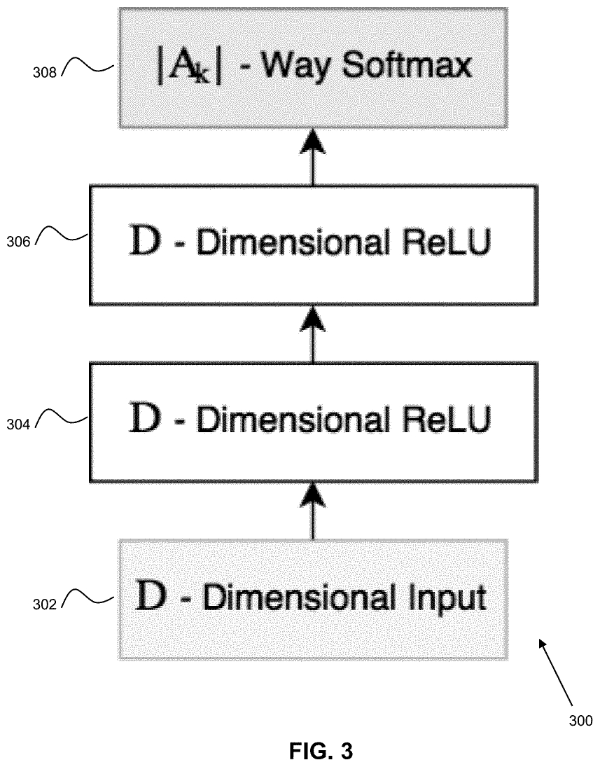

Exemplary classifiers include, for example, naïve Bayes (NB), support vector machines (SVMs, with a linear kernel Kₗᵢₙ(xᵢ, xⱼ)=xᵢ^{T}xⱼ), artificial neural networks (ANNs) and fastText, which is an efficient model for sentence classification that first learns an embedded representation of documents which are then fed into a multinomial logistic classifier. An exemplary ANN classification architecture is shown in FIG. 3. For each indicator variable, Aₖ, evaluated, the ANN (300) operates upon a D-dimensional vector input (302). The ANN comprises two rectified linear unit (ReLU) layers (304, 306), generating one-vs-rest |Aₖ| dimensional output (308), where |Aₖ| is the number of values that can be assigned to Aₖ.

The NB and SVM classifiers make use of lexical features that encode the probability of various unigrams and bigrams occurring in documents of a specific class. In embodiments, the labelling engine (104) uses tf-idf (term frequency-inverse document frequency) weighted unigram and bigram counts to determine the importance of unigrams and bigrams to the document under classification. The following five feature types are illustrative examples, wherein the first two are ‘bag of n-gram’ approaches, the next three are distributed representations, and the final one is a combination of several lexical-syntactic features.

Individual token frequency: Each document is represented by a vector where each element contains the number of times the unigram, or bigram, occurs in the document.

Token frequency with tf-idf weighting: By using the product of tf, and idf, words that are present in most documents (e.g., “the”, “a”, “is”) may be penalized.

Mean of global vectors (GloVe): GloVe vectors are distributed representations of words obtained by training aggregated global word-word co-occurrence statistics from a corpus. Here, features may be generated by averaging GloVe vectors corresponding to each word occurring in the corpus.

Mean of word2vec vectors: Word2vec is an alternative model for learning word embeddings from raw text. An exemplary model may be trained on an existing dataset, such as the Google News dataset, for example.

Document (doc2vec) vectors: Doc2vec is an extension of word2vec that learns fixed-length vector representations of documents by predicting document contents.

Lexical-syntactic features: These are obtained from syntactic parses and part-of-speech tagging of the corpus. These features may include:
(a) The relative frequency of context-free productions;
(b) Phrase-type proportion, rate, and mean length;
(c) Depth of syntactic parse trees;
(d) Subordination and coordination phrase ratios;
(e) Measures of word quality such as imageability, age-of-acquisition, familiarity, and transitivity; and
(f) Cosine distance between pairs of vectorized sentences within a document.

These feature and classifier types were evaluated in a validation of the presently described system. Exemplary results are shown below for illustrative assistance only, and are not intended as promises of particular performance in any specific implementation. Precision, recall, and F1 scores for each possible pair of feature and classifier type, averaged across the Indicator Variables, are shown in Table 2. In cases where indicator variables can take more than two values, the provided scores are the average for each value.

TABLE 2

| | | Mean | | |
|---|---|---|---|---|
| Feature | Model | Precision | Recall | F1 |
| Token ƒ | GNB | 0.81 | 0.78 | 0.79 |
| | SVM | 0.83 | 0.82 | 0.82 |
| | NN | 0.84 | 0.84 | 0.84 |
| | KNN | 0.77 | 0.77 | 0.76 |
| tf-idf | GNB | 0.83 | 0.79 | 0.81 |
| | SVM | 0.96 | 0.86 | 0.89 |
| | NN | 0.87 | 0.89 | 0.88 |
| | KNN | 0.72 | 0.69 | 0.67 |
| Word2Vec | GNB | 0.59 | 0.67 | 0.53 |
| | SVM | 0.77 | 0.63 | 0.64 |
| | NN | 0.86 | 0.84 | 0.85 |
| | KNN | 0.79 | 0.77 | 0.78 |
| GloVe | GNB | 0.60 | 0.66 | 0.54 |
| | SVM | 0.78 | 0.71 | 0.72 |
| | NN | 0.90 | 0.84 | 0.85 |
| | KNN | 0.79 | 0.76 | 0.772 |
| Doc2Vec | GNB | 0.61 | 0.65 | 0.57 |
| | SVM | 0.81 | 0.85 | 0.82 |
| | NN | 0.87 | 0.87 | 0.87 |
| | KNN | 0.85 | 0.84 | 0.85 |
| Lex-Syn | GNB | 0.59 | 0.65 | 0.53 |
| | SVM | 0.62 | 0.58 | 0.56 |
| | NN | 0.63 | 0.62 | 0.62 |
| | KNN | 0.53 | 0.47 | 0.38 |
| FastText | | 0.80 | 0.95 | 0.84 |

In these examples, using a corpus as described below, all combinations of feature-type and classifier-type yield high average scores. However, a combination of tf-idf weighted vectors and a linear SVM yield the best performance, with precision of 0.96 and recall of 0.89, with relatively little variation across indicator variables. The tf-idf weighted vectors outperform plain token-frequency vectors because they factor in the frequency of tokens in the corpus. This helps prevent the model from placing undue emphasis on less informative words that occur frequently in the corpus.

The performance of the ANN may be improved significantly by regularization. Possible over-fitting to the training data may be prevented by halting training once validation accuracy starts decreasing. Dropout layers may also be introduced to bias the network towards simpler models of the training data.

The relatively poor performance of the distributed vector representations, word2vec and GloVe, may be due to the composition of a single vector for each document by averaging out the vector representations of its constituent words. Order-sensitive representations such as sequence models and tree-structured LSTMs have fared better at generating semantic sentence representations that account for difference in meaning as a result of differences in word order or syntactic structure.

The generated indicator variable values are stored in the labelled index database (106), which is accessible to the clarification engine.

Moving now to query clarification on the basis of the indicator variables, the clarification engine (110) applies query clarification to refine search results. The clarification engine (110) automatically selects distinguishing questions for posing directly to the user, for example via an included user interface, wherein the possible answers to the distinguishing questions are related to the indicator variables.

In an embodiment, the query clarification technique comprises a modified ID3 technique to automatically construct an optimum decision tree given a corpus of data and associated labels to the data, to narrow down the search as quickly as possible. Each clarifying question reduces the number of search results, and each question corresponds to a branch in the decision tree. In a preferred embodiment, the question to be posed to the user is selected by greedily searching for the question that provides the most information gain at each branch, given training data. The search terminates when a sufficiently small number of results remains relevant.

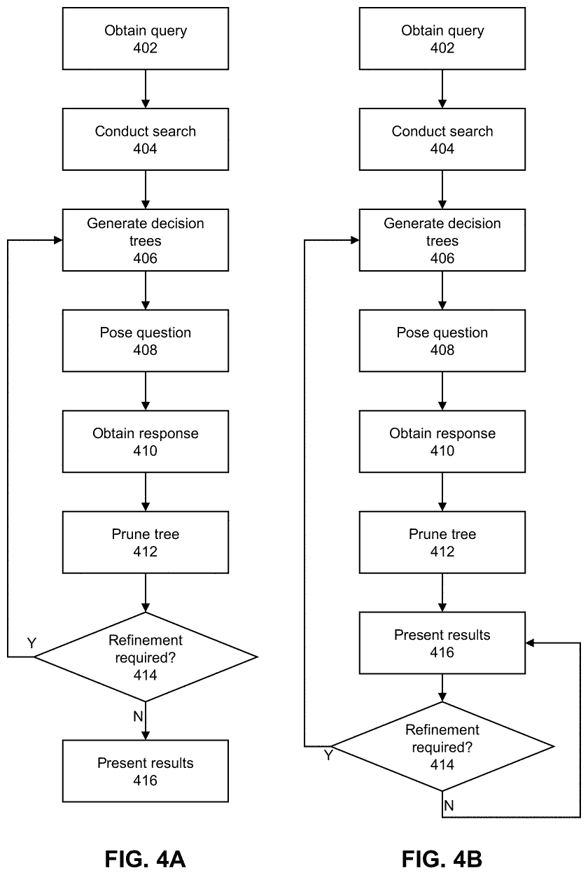

Referring now to FIG. 4A, a method of query clarification 400 is illustrated. The search engine (108) searches data in the corpus related to a search query. At block 402, the query is obtained from the user, as in known search techniques. The search engine does not necessarily have to take into account the indicator variables; rather, a content (text-based, for example) search can be conducted by the search engine.

At block 404, the search engine conducts the search against the corpus and returns the initial ranked results. In an example embodiment, the search engine (108) applies Apache™ Solr™, an open-source, full-text search engine. Search queries are conducted against the SoIr instance, and the set of search results consist of the top n relevant documents, ranked according to their Okapi BM25 scores. Given a query Q (containing keywords q₁, . . . , qₙ), the BM25 score of a document D is expressed as:

$$score ( D , Q ) = {\sum }_{i = 1}^{n} IDF ( {q}_{i} ) \cdot \frac{f ( {q}_{i} , D ) \cdot ( {k}_{1} + 1 )}{\begin{matrix}f ( {q}_{i} , D ) + {k}_{1} \cdot \\ ( 1 - b + b \frac{\vert D \vert}{avgdl} )\end{matrix}} \qquad ( 1 )$$

where: f (qᵢ, D) is the term frequency of qᵢ in the document D; IDF(qᵢ) is the inverse document frequency weight of the query term qᵢ; |D| is the length of document D in words; avgdl is the average document length in the text collection; and k₁ and b are free parameters either set to defaults or chosen through optimization.

The clarification engine (110) utilizes the indicator variables for the search results (that is, the top n relevant documents) obtained from the search engine (108). To determine which indicator variable to utilize in a clarification question, at block 406, the clarification engine (110) first generates decision trees from among the search results.

In an example embodiment, the clarification engine (110) implements a modified ID3 algorithm to generate decision trees from the search results. Given the set of search results C, the clarification engine calculates the information gained in knowing the value of each attribute Aₖ, where A is the set of indicator variables and k is each indicator variable. The indicator variable with the largest potential information gain is then used to split C into subsets according its value, producing a node in the decision tree. At block 408, the clarification engine (108) directs the user interface (112) to pose a question to the user to provide a label for the indicator variable that will provide the largest information gain, and gathers the user response accordingly at block 410.

In one embodiment, the clarification engine then iterates recursively on the resulting subsets of C. However, it may be preferred that the clarification engine not generate a single decision tree a priori for all possible queries, but instead in producing a decision tree dynamically according to the user's preferences and initial input. In this embodiment, the clarification engine configures a question to be posed by the user interface to the user, such that the user specifies values aᵢ to attributes Aₖ after each iteration. In this embodiment, the ID3 algorithm is modified so that, at block 412, all irrelevant branches are pruned after each iteration based on information from the user. Thus, the clarification engine can be configured to pose new questions to the user at each utilized (unpruned) branch along the decision tree, wherein the question to present to the user is preferably the one with the highest expected information gain.

The clarification engine determines information gain by use of the probability that the user's answer to each question is accurate, and that the desired search result will be found in the set of documents represented within that answer. Search is directed toward determining which documents in a working set, D, are relevant to the user's needs. The uncertainty about the possible relevance of each document can be expressed as a function of a discrete probability distribution P(D) as shown in Equation 2, which is the likelihood that the user will find a desired document in the working set. For simplicity, it may be assumed that the user is only interested in a specific document in D, and initially P(D)=1/|D|, but this assumption is open to change.

$$\begin{matrix}\begin{matrix}H ( D ) = - {\sum }_{d ∈ D} P ( d ) {log}_{ 2} P ( d ) \\ = - {\sum }_{d ∈ D} \frac{1}{\vert D \vert} {log}_{ 2} \frac{1}{\vert D \vert}\end{matrix} & ( 2 )\end{matrix}$$

The uncertainty present after the user reveals an answer a to the question Aₖ can similarly be expressed as a function of a probability density function P(D|Aₖ=a), as shown in Equation 3.

H(D|Aₖ=a)=−P(D|Aₖ=a)log₂ P(D|Aₖ=a) (3)

Once again, for the sake of simplicity, it may be assumed that the user's answer is accurate and the one relevant document is present in the set documents whose attribute Aₖ=a. This permits use of a P(D|Aₖ=a) as expressed in Equation 4.

$$P ( D \vert {A}_{k} = a ) = ( \begin{matrix}\frac{1}{\vert {D}_{{A}_{k} = a} \vert} & for 0 < \vert {D}_{{A}_{k} = a} \vert \\ 0 & for \vert {D}_{{A}_{k} = a} \vert = 0\end{matrix} \qquad ( 4 )$$

The full information gain of obtaining any answer to a question corresponding to indicator variable Aₖ is the difference between the initial uncertainty H(D) and the average uncertainty after revealing some value a of Aₖ. The latter is found by taking into account P(Aₖ=a), the probability that the user would give the answer a. In some embodiments, personalization, including historical data such as past user interactions, may be used to estimate this value. However, since it may be the case that personalization is non-existent or insufficient, the clarification engine (110) may estimate it using the fraction of documents in the index corresponding to the provided answer, i.e.,

$$P ( {A}_{k} = a ) = \frac{\vert {C}_{{A}_{k} = a} \vert}{\vert C \vert} \qquad ( 5 )$$

The final expression for information gain is provided in Equation 6 and can be expressed as a function of document counts by plugging in Equations 2, 3, 4, and 5.

$$\begin{matrix}\begin{matrix}IG ( D , {A}_{k} ) = H ( D ) - H ( D \vert {A}_{k} ) \\ = H ( D ) - {\sum }_{a} P ( {A}_{k} = a ) H ( D \vert {A}_{k} = a )\end{matrix} & ( 6 )\end{matrix}$$

The clarification engine (110) correspondingly selects the indicator variable Aₖ that results in the maximal IG, and prompts the user to provide an answer a to the clarifying question corresponding to that variable. The clarification engine then updates D such that D=D_{A}_{ₖ}₌ₐ, and repeats the process until a sufficiently small set of relevant search results, |D|, is generated at block 414, at which point the remaining search results can be provided to the user via the user interface (112) at block 416. The number of search results meeting this threshold may be configured based on the application desired, such as a single result for a virtual assistant, or a set of 10-20 search results for a search engine web page, or any other desired number.

In alternative embodiments as shown in FIG. 4B, search results may be presented to the user at block 416 via the user interface (112) prior to determining whether a refinement is required at block 414. For example, search results may be displayed concurrently with the questions used to prune the tree. In such a case, selecting an answer to a question applies that “filter” to prune the tree, and the filtered results are presented to the user. In this way, users can decide if they want to narrow the results further or if they are satisfied with the results as is.

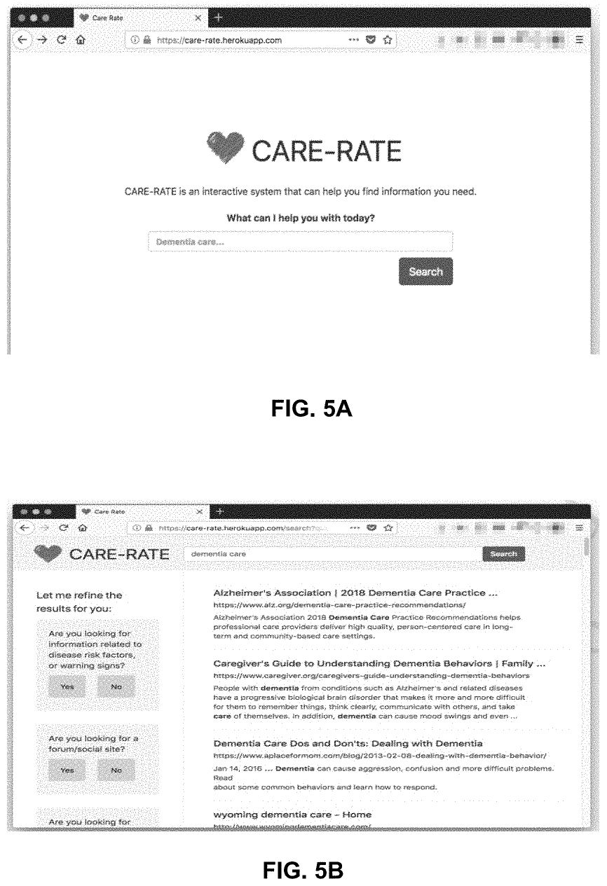

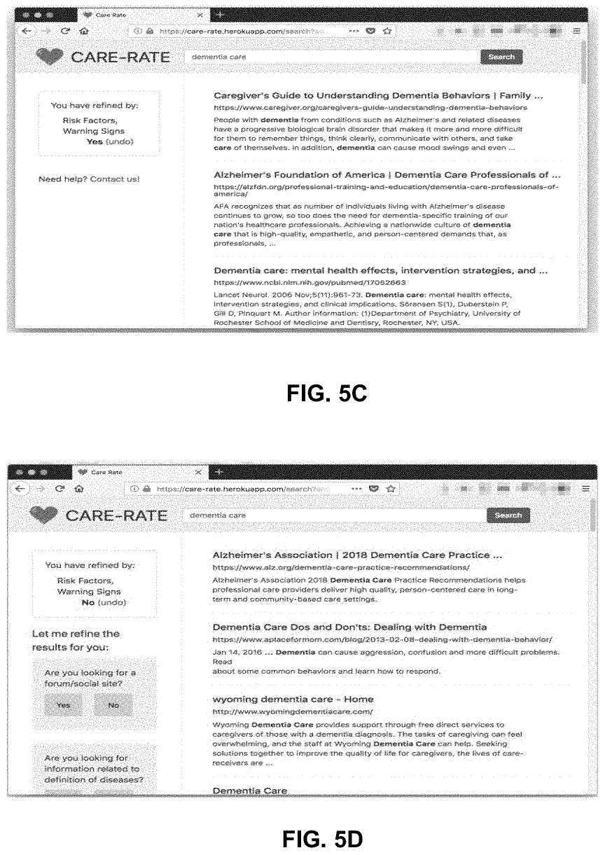

FIG. 5A to 5D illustrate exemplary web based user interfaces for permitting access to the present system by a user. This user session corresponds to the flowchart illustrated in FIG. 4.

FIG. 5A is a landing page for the system. In FIG. 5B, the user is provided with an unfiltered (prior to query clarification) listing of search results relating to a search query, along with a list of clarifying questions ranked by their information gain. FIG. 5B corresponds to the method illustrated in FIG. 4B, wherein interim search results are presented to the user concurrently with clarifying questions useful for further filtering the search results, and the user can optionally select to filter the search results further. Additionally, FIG. 5B illustrates that the user interface (112) can be configured to present to the user a plurality of candidate questions with candidate answers. In the example shown, the questions are presented in order from most information gain (the highest placed question) and descending therefrom.

In FIG. 5C, the user has responded with the answer “Yes” to the first posed question, enabling the clarification engine to narrow the search results. In FIG. 5D, the user has responded with the answer “No” enabling the clarification engine to narrow the search results, as well as provide further clarifying questions.

It will be appreciated that the techniques described herein need not be practiced in isolation. For example, the search engine (108) could incorporate third party search techniques, such as query expansion, personalization, ranking techniques, etc. without detracting from the presently described system and method.

For example, if a search engine uses query expansion to recommend alternate queries, it would be prudent to give prominence to rewritten queries that will benefit the most from query clarification. Equations 7 to 12, below, provide an example of how to select an optimal (rewritten query, clarifying question) pair.

The information gain (IG) offered by each query-question pair is calculated by considering how their respective values would partition the set of documents C_{Q=q}, where C_{Q=q}⊆C, and Q is a variable that indicates whether or not a document in the collection C would be in the search results returned after searching for query q.

$$\begin{matrix} IG ( Q , {A}_{k} ) = H ( Q ) - H ( Q \vert {A}_{k} ) \approx - H ( Q \vert {A}_{k} ) & ( 7 ) \\ H ( Q \vert {A}_{k} ) = - {\sum }_{{a}_{i} ∈ {A}_{k}} P ( {a}_{i} ) H ( Q \vert {A}_{k} = {a}_{i} ) & ( 8 ) \\ H ( Q \vert {A}_{k} ) = - {\sum }_{{a}_{i} ∈ {A}_{k}} P ( {a}_{i} ) {\sum }_{q ∈ Q} P ( q \vert {a}_{i} ) {log}_{ 2} ( P ( q \vert {a}_{i} ) ) & ( 9 ) \\ H ( Q \vert {A}_{k} ) = - {\sum }_{{a}_{i} ∈ {A}_{k}} {\sum }_{q ∈ Q} P ( q , {a}_{i} ) {log}_{ 2} ( \frac{P ( q , {a}_{i} )}{P ( {a}_{i} )} ) & ( 10 ) \\ H ( Q \vert {A}_{k} ) = - {\sum }_{{a}_{i} ∈ {A}_{k}} {\sum }_{q ∈ Q} \frac{\vert {C}_{Q = q , {A}_{k} = {a}_{i}} \vert}{\vert C \vert} {log}_{ 2} ( \frac{\vert {C}_{Q = q , {A}_{k} = {a}_{i}} \vert}{\vert C \vert} \div \frac{\vert {C}_{{A}_{k} = {a}_{i}} \vert}{\vert C \vert} ) & ( 11 ) \\ H ( Q \vert {A}_{k} ) = - {\sum }_{{a}_{i} ∈ {A}_{k}} {\sum }_{q ∈ Q} \frac{\vert {C}_{Q = q , {A}_{k} = {a}_{i}} \vert}{\vert C \vert} {log}_{ 2} ( \frac{\vert {C}_{Q = q , {A}_{k} = {a}_{i}} \vert}{\vert {C}_{{A}_{k} = {a}_{i}} \vert} ) & ( 12 )\end{matrix}$$

Although the invention has been described with reference to certain specific embodiments, various transformations thereof will be apparent to those skilled in the art. The scope of the claims should not be limited by the preferred embodiments, but should be given the broadest interpretation consistent with the description as a whole.

1. A system for query clarification applied to a set of search results generated by a search query performed on a corpus of data, the system comprising one or more processors configured to execute:
a labelling engine to apply to each datum within the corpus a label corresponding to each one of a plurality of predetermined indicator variables, each indicator variable relating to context of the respective data; and
a clarification engine to:
generate a decision tree using the set of search results, the decision tree comprising nodes corresponding to the indicator variables and edges corresponding to the labels, the decision tree generated to maximize information gain based on pruning the decision tree in response to obtaining a desired label for a selected indicator variable; and
prune the decision tree in response to a question posed to a user to obtain a label for an indicator variable.

2. The system of claim 1, wherein each indicator variable corresponds to a question and each label of associated edges corresponds to an answer associated with the question.

3. The system of claim 1, wherein each indicator variable represents a category of interest to a particular field represented by the corpus of data.

4. The system of claim 1, wherein at least one of the labels is unknown.

5. The system of claim 1, wherein each datum in the corpus comprises one or more webpages.

6. The system of claim 5, wherein at least a portion of the data are manually labelled and the labelling engine applies inheritance of the labels to webpages associated with the manually labelled data.

7. The system of claim 1, wherein the labelling engine uses a trained supervised learning classifier for each of the indicator variables to label the data, the supervised learning classifier trained using a set of manually labelled data for training and testing.

8. The system of claim 1, wherein maximizing information gain comprises determining the information gained in knowing a value of each indicator variable, the indicator variable with a largest potential information gain being used to split the search results into subsets according its value to produce a node in the decision tree, and wherein the question posed to the user results in obtaining a label or value for the indicator variable.

9. The system of claim 8, wherein the clarification engine iteratively performs, to prune the decision tree, determining the information gained and posing the question to the user that will provide the largest information gain.

10. The system of claim 8, wherein information gain is determined by determining a probability that the answer provided by the user to each question is accurate, and that a desired search result to the search query will be found in the set of documents represented within that answer.

11. A computer-implemented method for query clarification applied to a set of search results generated by a search query performed on a corpus of data, the method comprising:
applying to each datum within the corpus a label corresponding to each one of a plurality of predetermined indicator variables, each indicator variable relating to context of the respective data;
generating a decision tree using the set of search results, the decision tree comprising nodes corresponding to the indicator variables and edges corresponding to the labels, the decision tree generated to maximize information gain based on pruning the decision tree in response to obtaining a desired label for a selected indicator variable; and
pruning the decision tree in response to a question posed to a user to obtain a label for an indicator variable.

12. The method of claim 11, wherein each indicator variable corresponds to a question and each label of associated edges corresponds to an answer associated with the question.

13. The method of claim 11, wherein each indicator variable represents a category of interest to a particular field represented by the corpus of data.

14. The method of claim 11, wherein at least one of the labels is unknown.

15. The method of claim 11, wherein each datum in the corpus of data comprises one or more webpages.

16. The method of claim 15, wherein at least a portion of the data are manually labelled and the labelling engine applies inheritance of the labels to webpages associated with the manually labelled data.

17. The method of claim 11, applying the label comprises using a trained supervised learning classifier for each of the indicator variables to label the data, the supervised learning classifier trained using a set of manually labelled data for training and testing.

18. The method of claim 11, wherein maximizing information gain comprises determining the information gained in knowing a value of each indicator variable, the indicator variable with a largest potential information gain is used to split the search results into subsets according its value to produce a node in the decision tree, and wherein the question posed to the user comprises posing a question to the user results in obtaining a label or value for the indicator variable.

19. The method of claim 18, wherein pruning the decision tree comprises iteratively determining the information gained and posing the question to the user that will provide the largest information gain.

20. The method of claim 18, wherein information gain is determined by determining a probability that the answer provided by the user to each question is accurate, and that a desired search result to the search query will be found in the set of documents represented within that answer.
